(19) United States
(12) Patent Application Publication
(10) Pub. No.: US 2007/0111169 A1
(43) Pub. Date: May 17, 2007

(54) Interactive Story Development System with Automated Goal Prioritization

(75) Inventors: Stacy C. Marsella, Playa del Rey, CA (US); David V. Pynadath, Venice, CA (US)

Correspondence Address: McDERMOTT WILL & EMERY LLP, Suite 3400, 2049 Century Park East, Los Angeles, CA, 90067, US

(73) Assignee: University of Southern California

(21) Appl. No.: 11/464,394

(22) Filed: Aug. 14, 2006

Related U.S. Application Data
(60) Provisional application No. 60/708,270, filed on Aug. 15, 2005.

(51) Int. Cl. G09B 9/00

(52) U.S. Cl. 434/1

(57) ABSTRACT

An interactive story development system for developing an interactive story having a plurality of agents may have an action input system configured to receive actions that the agents should perform, and a goal-fitting system configured to prioritize a plurality of goals for each agent based on the actions received by the action input system.

### CROSS-REFERENCE TO RELATED APPLICATION(S)

This application is based upon and claims priority to U.S. Provisional Patent Application Ser. No. 60/708,270, filed Aug. 15, 2005, entitled “PsychSim: Multi-Agent Based Social Simulation,” attorney docket number 28080-184, the entire content of which is incorporated herein by reference.

### STATEMENT REGARDING FEDERALLY SPONSORED RESEARCH

This invention was made with government support under the Office of Assistant Secretary for Defense for SOLIC, Via Institute for Defense Analysis, Grant No. A-46822. The government may have certain rights in the invention.

### BACKGROUND

1. Field

This application relates to interactive story development systems that utilize autonomous, goal-oriented agents.

2. Related Art

A user often plays the role of a character in a computer-generated story. The story often includes other characters (commonly called “agents”) that act autonomously in response to actions of the user's character.

These interactive stories may be programmed to mimic real life situations, such as attending a party, meeting someone for the first time, a breakup of a couple's marriage, negotiating a deal, solving a crime, a terrorist attack, and going on a mission to another planet. Programming the interactive story to faithfully mimic these real life situations, however, can be challenging.

One approach is to utilize what is known as a rule-based system. A set of rules is created that dictate responses by the other characters to each of the anticipated actions of the user's character.

Another approach is to program each of the autonomous characters with one or more goals that they should achieve. The characters then act autonomously to achieve these goals in response to actions of the user's character, without having to program rules for every possible action and circumstance.

Regardless of the approach, trial and error is often used to perfect the programming. A user controls his character, the other characters respond in accordance with their programming, and adjustments to the programming are made to cause these responses to be more realistic. This trial and error process, however, can be very time-consuming, often taking months and sometimes even years. Even then, the degree of realism may be less than is desired.

### BRIEF SUMMARY

An interactive story development system for developing an interactive story having a plurality of agents may have an action input system configured to receive actions that the agents should perform, and a goal-fitting system configured to prioritize a plurality of goals for each agent based on the actions received by the action input system.

The actions may include dialog and non-verbal movements that the agents should perform.

The input system may be configured to receive actions in the form of menu selections.

The actions may include speech acts, each of which contains the content of a speech communication.

The actions may include a sequence of speech acts that collectively constitute at least part of a story.

The actions may include alternate speech acts, each of which constitutes an alternate path in a story.

Each speech act may include a specification of a type of speech, the name of the agent articulating the speech, the name of the agent to whom the speech act is directed, and/or a proposition.

The action input system may be configured to receive different types of propositions.

The speech acts and the propositions may be received in the form of menu selections.

The interactive story development system may include an object attribute input system configured to receive identifications of objects that may be used in the story and attributes of each object. The objects may include agents and the attributes may include attributes of the agents. The object attribute input system may be configured to receive information about relationships between the agents.

The goal-fitting system may be configured to extract goals from attributes of agents.

The interactive story development system may include an action dynamics input system configured to receive action dynamics indicative of how actions of the agents affect attributes of the agents. The goal-fitting system may be configured to prioritize the plurality of goals also based on the action dynamics.

The goal-fitting system may be configured to prioritize the goals for each agent based on whether the action dynamics indicates that the goals are furthered by actions that the agent should perform as compared to actions that the agent should not perform. The goal-fitting system may be configured to increase the priority of a goal when action dynamics indicate that the goal is furthered more by the action that the agent should perform than by the alternate actions available to the agent. Likewise, it may decrease the priority of a goal when action dynamics indicate that the goal is furthered less by the action that the agent should perform than by the alternate actions.

The goals of an agent may include maximizing or minimizing attributes of the agent, changing a belief about the agent in the mind of another agent, bringing about an action by the agent, and/or bringing about an action by another agent.

The developing system may be configured to allow a user to control an agent during the interactive story after the goals of the other agents have been prioritized by the goal-fitting system and while the other agents act autonomously with those prioritized goals.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 illustrates components of an interactive story development system.

FIG. 2 is a table of illustrative speech acts.

FIG. 3 is a table of illustrative event propositions.

FIG. 4 is a table of illustrative object propositions.

FIG. 5 is a table of illustrative object names.

FIG. 6 is a table of illustrative objects in a scene.

FIG. 7 is a table of illustrative agent relationships.

FIG. 8 is a table of illustrative initial agent attributes.

FIG. 9 is a table of illustrative action dynamics.

FIG. 10 is a table of illustrative goal priorities.

### DETAILED DESCRIPTION OF ILLUSTRATIVE EMBODIMENTS

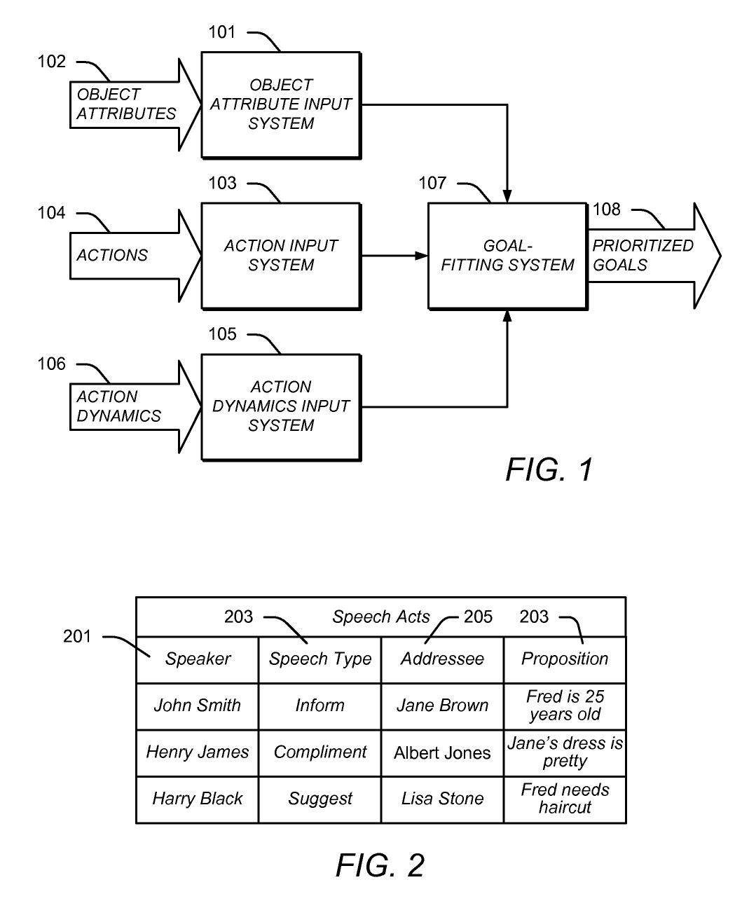

FIG. 1 illustrates components of an interactive story development system. As shown in FIG. 1, the interactive story development system may include an object attribute input system 101 configured to receive object attributes 102, an action input system 103 configured to receive actions 104, an action dynamics input system 105 configured to receive action dynamics 106, and a goal-fitting system 107 configured to receive information from the object attribute input system 101, the action input system 103, and the action dynamics input system 105.

The object attribute input system 101, the action input system 103, and the action dynamics input system 105 may each include a user interface. Each user interface may include any type of device or devices that communicate with a user, such as one or more keyboards, mice, joysticks, displays, touch screens, microphones, and/or sound systems. Each of these components may have its own user interface or share a user interface with one or more of the other components.

The object attribute input system 101, the action input system 103, and the action dynamics input system 105 may each include a storage system configured to store information which these components receive through their respective user interface. Each storage system may include one or more storage devices, such as hard disks, flash drives, etc. Each of these components may have its own storage system or share a storage system with one or more of the other components

The object attribute input system 101, the action input system 103, and the action dynamics input system 105 may each include database management systems. Each database management system may include database management software. Each of these components may have its own database management system or share a database management system with one or more of the other components.

The object attribute input system 101, the action input system 103, the action dynamics input system 105, and the goal-fitting system 107 may each be implemented with one or more computer processing systems, such as one or more personal computers. These components may share computer processing systems or each have their own. The computer processing systems may be at a single location or distributed across multiple locations. Different components of the computer systems may communicate with one another using any means, such as computer buses, local area networks, wide area networks, the internet, wireless networks, etc.

Specific functions of the object attribute input system 101, the action input system 103, the action dynamics input system 105, and the goal-fitting system 107 will now be described. These are merely illustrative. Each of these systems may be configured to perform one or more of these functions and/or other functions. Each may include appropriate software, including operating systems and application software, to aid in accomplishing these functions.

The actions 104 may be information that describes actions that agents in an interactive story should perform. It may also include actions that the agents should not perform. The actions 104 may include dialogue as well as non-verbal movements, such as gestures and physical actions. One or more groups of the actions 104 may represent a sequential story or part of a story. A set of actions may instead constitute alternate paths in a story, the choice of which may depend on one or more other circumstances.

One type of action 104 may be a speech act that contains the content of a speech communication.

FIG. 2 is a table of illustrative speech acts. As reflected by FIG. 2, the content of a speech act may be specified by a set of field values. The field values may be a speaker 201, a speech type 203, an addressee 205, and a proposition 207. Other types of fields may be used in addition or instead.

The speaker 201 may identify the agent in the interactive story that is articulating the speech. The speech type 203 may represent the type of the speech. Any type may be used. For example, the types may include greet, bye, thank, inquiry, inform, request, offer, accept, reject, suggest, yes/no questions, confirm, deny, and compliment. A different set of types, including types that have not been listed, may be used instead.

The addressee 205 may indicate the agent to whom the speech is directed. Although only a single agent is indicated in FIG. 2, a speech act may be directed to multiple agents, in which case the names of the multiple agents may be specified.

The actions 104 may include speech acts over a variety of different types of propositions 203, such as event propositions and/or object propositions, each of which may be specified by their own set of field values.

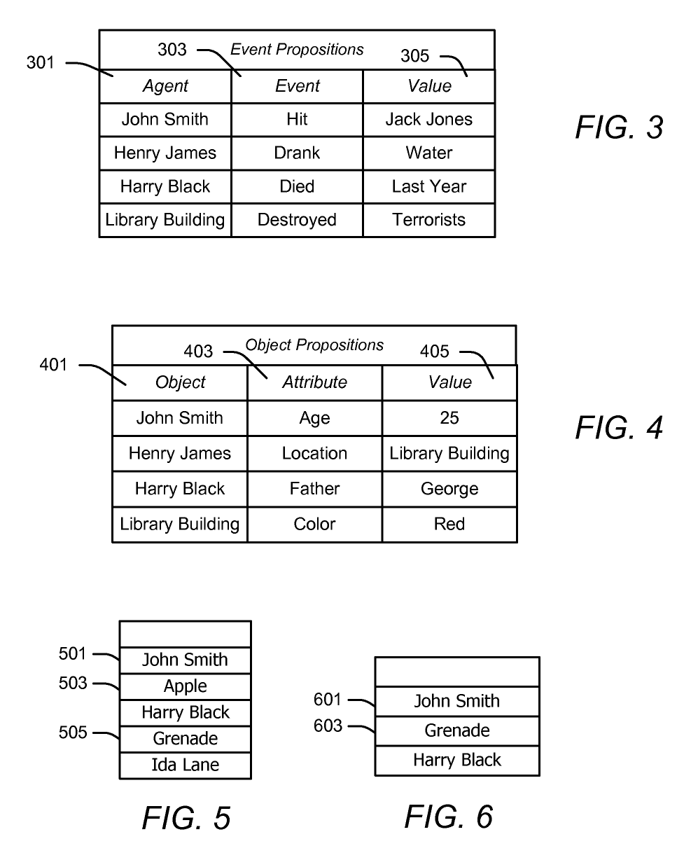

FIG. 3 is a table of illustrative event propositions. As shown in FIG. 3, each event proposition may be specified by a set of field values, such as the name of an agent 301 that is perpetrating the event, a description of the event 303, and a value 305 of the event. Various examples are illustrated in FIG. 3 to demonstrate the types of information that may be received. Other types of fields may be used in addition or instead.

FIG. 4 is a table of illustrative object propositions. As shown in FIG. 4, each object proposition may be specified by a set of field values, such as an identification of an object 401, an attribute 403 of the object, and a value 405 of the attribute. As reflected by the table shown in FIG. 4, an object may be an agent in the scene. An object may instead be something other than an agent, such as a physical object in the scene. A library building 407 is an example. Other types of fields may be used in addition or instead.

The object attributes 102 may identifying objects that may be used in the story and attributes of each object. An object may include an agent and attributes that the agent may have. An object may instead be something other than an agent, such as a tangible object in the scene and attributes of that tangible object.

FIG. 5 is a table of illustrative agent names. Each name may be received as part of the object attributes 102. As mentioned above and reflected by the object names in FIG. 5, an object may be an agent, such as agent John Smith 501. An object may instead be something other than an agent, such as an apple 503 or a grenade 505.

FIG. 6, for example, is a table of illustrative objects in a scene. This table may be supplied as part of the object attributes 102. As reflected by FIG. 6, the objects in a scene may include agents, such as agent John Smith 601, as well as non-agent objects, such as a grenade 603.

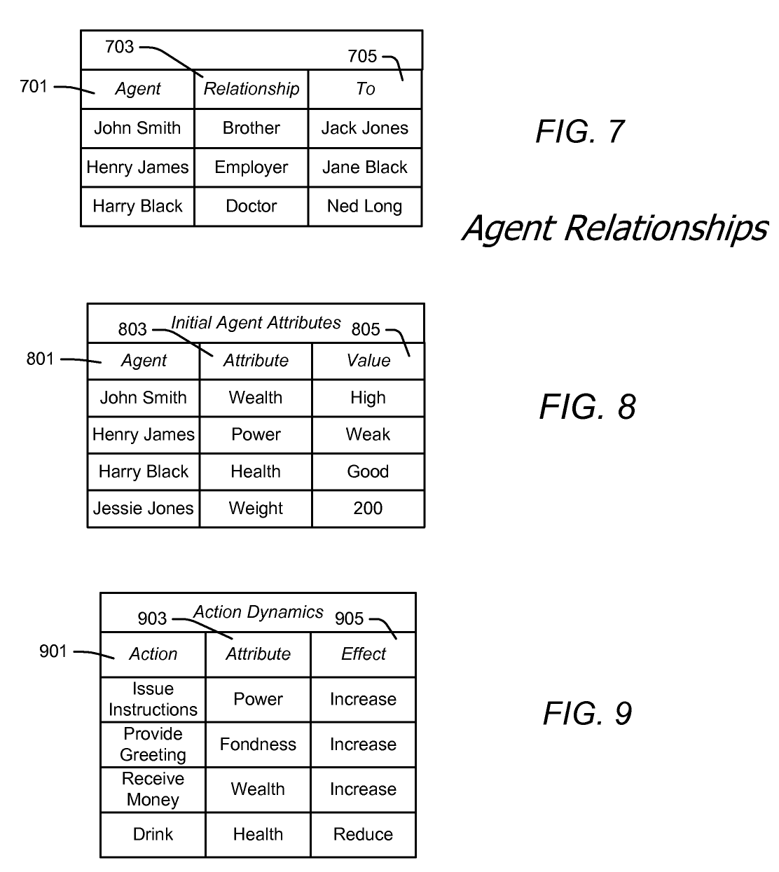

FIG. 7 is a table of illustrative agent relationships. Relationships between two or more agents may be specified as part of the objects attributes 102. As reflected by FIG. 7, the relationships may be specified by a set of field values, such as a name of an agent 701, the relationship 703, and the name of the agent with whom the identified agent has the relationship, i.e., a “To” field 705. Although not illustrated in FIG. 7, the object attributes 102 may include relationships between non-agent objects. Other types of fields may be used in addition or instead.

FIG. 8 is a table of illustrative initial agent attributes. A list of initial agent attributes may be specified as part of the object attributes 102. As reflected by FIG. 8, the initial agent attributes may be specified by a set of field values, such as an agent 801 that has the attribute, a type of attribute 803, and a value 805 for the attribute. Other types of fields may be used in addition or instead.

One or more of the object attributes 102 may be treated during the interactive story as merely an initial attribute for an agent. Changes to one or more of these initial attributes may be made during the story based on what takes place. Other object attributes 102 may be fixed during the interactive story and not subject to change.

The object attributes 102 may be attributes of non-agent objects. For example, an object that is a library building may have an attribute of temperature and a value of 100°.

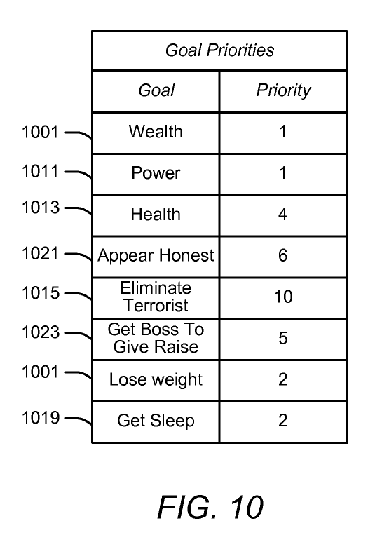

The action dynamics 106 may be indicative of how actions of the agents affect attributes of the agents. FIG. 9 is a table of illustrative action dynamics. As illustrated in FIG. 9, the action dynamics 106 may be specified as a set of field values, such as an action 901, an attribute 903 that the action 901 affects, and effect 905 of the action 901 on the attribute 905. Although not shown in FIG. 9, the action dynamics 106 may specify that a single action affects multiple attributes. Although not shown in FIG. 9, a magnitude may be specified for each increase or decrease. Also, each increase or decrease may depend on conditions of object attributes, such as providing a greeting to someone who hates you will not increase fondness.

The object attribute input system 101, the action input system 103, and the action dynamics input system 105 may each be configured to receive information, such as the field values discussed above in connection with each of them, in the form of menu selections and/or blanks that a user fills in. Menu selections may be more appropriate for values that should be limited to a list, while blanks may be more appropriate for values that make up a list or that otherwise are not easy to anticipate.

The goal-fitting system 107 may be configured to prioritize a plurality of goals for each agent in the story. The goals that may be prioritized by the goal-fitting system 107 may be of any type. For example, the goals may include maximizing or minimizing one or more attributes of an agent, such as to maximize the wealth of an agent or to minimize his weight. A goal may be to bring about certain action, such as to become wealthy or to capture terrorists. A goal may be to cause another agent to take action, such as to terrorists to surrender or to stop their acts of terror. A goal may be to change a belief about the agent in the mind of another agent, such as to cause an agent's boss to believe that the agent is performing his job competently.

FIG. 10 is a table of illustrative goal priorities. Some of these may be to maximize an attribute of an agent, such as wealth 1001, power 1011, and health 1013. Others may be to bring about action, such as eliminate terrorist 1015, lose weight 1017, and get sleep 1019. Still others may be to cause another to take action, such as get boss to give raise 1023. Still others may be to affect how the agent is perceived by another agent, such as appear honest 1021.

FIG. 10 also illustrates priorities that the goal-fitting system 107 has determined for each of the goals. As illustrate in FIG. 10, the goal of eliminating terrorist 1015 has been given the highest priority, while the goals of wealth 1001 and power 1011 have been given the lowest priority.

The goal-fitting system 107 may use any approach for identifying the goals and determining their priority.

In one embodiment, the goal-fitting system 107 may be configured to extract the goals from the agents attributes that may be part of the object attributes 102, the actions 104 and/or the action dynamics 106. For example, the goal-fitting system 107 may be configured to extract as the goals to be achieved: age and location from the table illustrated in FIG. 4; wealth, power, health and weight from the table illustrated in FIG. 8; and/or power, fondness, wealth, and health from the table illustrated in FIG. 9. The goal-fitting system 107 may be configured in addition or instead to receive an itemization of one or more goals from a programmer and/or user.

The goal-fitting system 107 may be configured to initially rank each goal for each agent equally or in a manner specified by a user. The goal-fitting system 107 may then examine each of the actions 104 for each agent that have been received and stored by the action input system 103. For each of the action 104, the goal-fitting system 107 may consult the action dynamics 106 that have been received and stored by the action dynamics input system 105 for the purpose of determining which goals of the agent are furthered or hampered by the action. The goal-fitting system may then adjust the prioritization of these goals accordingly.

For example, one of the actions 104 may be the acquisition of money. The action dynamics 106 may indicate that the acquisition of money increases wealth. If the acquisition of money is one of the actions that the agent should perform, the goal-fitting system 107 may therefore increase the priority given to the goal of wealth in relation to other goals. In other words, the goal-fitting system 107 may assume that the actions taken by an agent are in furtherance of the agent's goals and thus prioritize these goals by increasing the priority of goals that are being furthered by the actions that it should perform and by decreasing the priority of goals that are furthered by its alternate actions. The goal-fitting system 107 may be configured to continue adjusting the priorities of these goals while going through each of the actions 104 for each of the agents based on the action dynamics 106. The result may be a table such as is shown in FIG. 10 for each agent.

The components that have thus-far been described may be used in any way. Examples are now set forth.

In one embodiment, the development of a story may begin with one or more authors preparing one or more scripts. Each script may describe scenarios that are typical for the interactive story that is being developed. Each script may include dialogue and/or nonverbal movements of characters, as well as descriptions of the surrounding environment and changes in that environment.

The types of information discussed above that are received by the object attribute input system 101, the action input system 103, and/or the action dynamics input system 105 may then be extracted from these scripts and entered the respective input system. As explained above, this information may be entered through the use of menu selections and/or filling in blanks or through other means.

Following the entry of this information, the goal-fitting system 107 may be directed to extract the goals of each agent and to prioritize those goals. The goal-fitting system 107 may do so using any technique, such as one or more of the techniques that have been described above.

A user may then take control of any one or more of the agents in the interactive story. For example, the user may take control of the words that are spoken by a particular agent and/or the nonverbal movements that the particular agent makes. The user may do so through an appropriate user interface, such as through the use of a keyboard, mouse, joystick, microphone, touch screen, and/or any other device or combination of devices.

The other agents in this scene may be configured to respond autonomously to the actions taken by the user's character (or characters) based on the goals and goal priorities that have been determined for them by the goal-fitting system 107.

Sometime, there may be a conflict between the goals of an autonomous agent. For example, an autonomous agent may have the goal of staying alive and the goal of protecting his family. The interactive story may come to a point at which the next action of the character can only further one of these two goals, while diminish the ability of the agent to accomplish the other goal. In such a situation, the software that is managing the interactive game may be configured to resolve this conflict by having the autonomous agent perform the action that furthers the goal with the higher priority. If protecting his family is the goal with the higher priority, the autonomous agent may risk his own life to protect his family. By taking actions that further their goals and by resolving conflicts among these goals based on the priorities that have been determined by the goal-fitting system 107, the autonomous agents may be able to act in a fashion that faithfully replicates the real world situation that is being simulated.

The goal with the highest priority may not always take precedent. Consideration may also be given to the degree to which each possible action may further or detract from a goal. In one embodiment, for example, each goal priority may be multiplied by the degree to which the action would further the goal and the system may direct the agent to implement the action that yields the highest product.

For example, the agent in the example above may rush into a burning building to save his children. In such a case, the action of doing so may decrease the agent's welfare greatly, but not doing so may decrease his children's welfare by at least the same amount. If the agent's goal of maximizing his family's welfare has a higher priority than his goal of maximizing his own, then the system would direct him to go into the burning building, as described above. However, if his children were already safe, but their frog was still in the building, saving the frog would still increase his children's welfare, but only by a much smaller amount. On the other hand, the risk to the agent's own life may still be high. Although the agent's welfare may be a lower priority than his children's, the system may choose not to have the agent rush in. It may do so by multiplying the goal priority by the degree to which the action would further the goal. In this example, going into the building may have a value equal to the (priority of children's welfare)*(benefit to children's welfare)−(priority of character's welfare)*(cost to character's welfare). If this value exceeds 0, then the character may be directed to go into the building. In the case where the children are in the building, the “benefit to children's welfare” may be high enough so that the value exceeds 0. But in the case where only the frog is inside, the “benefit to children's welfare” may be much lower, so it may be outweighed by the “cost to character's welfare” term.

The system may also consider the probability of outcomes by including this factor among the factors that are multiplied together. A person who thought it was likely that he could rush into the building and come out with the frog unscathed, for example, might make a different decision than someone who thought it was likely he would not survive the rescue attempt.

Information about other actions taken by the autonomous agents, such as words that they speak or non-verbal movements that they make, such as gestures and physical movements, as well as information about other objects in the environment, may be communicated back to the user through a user interface. For this purpose, the user interface may include one or more displays, sound systems, and/or tactile devices.

The interactive story development system that has thus-far been described may be used to simulate any type of story. In each case, judicious choices may be made for the information that is input to the object attribute input system 101, the action input system 103, and the action dynamics input system 105.

In one embodiment, the interactive story development system may be used to develop stories that have an overall didactic or teaching goal. In this embodiment, actions 104 may be provided that reward an agent for conduct indicative of learning successes and penalize the agent for conduct indicative of learning failures. If the didactic goal is to teach a person how to interact with others in a foreign country, for example, the actions 104 may include actions in which the foreigner responds favorably to student action that conforms with the foreigner's cultural norms, and actions in which the foreigner responds unfavorably to student actions that fail to conform with these cultural norms.

When speech acts are used that have propositions, the nature of the speech acts and propositions may be tailored to the didactic goal. For example, the didactic goal may be to teach the importance of establishing trust with characters, and the greeting speech act may impact trust. A student that fails to greet a character or that provides an improper greeting may cause the character to reduce his trust in the student. The reduced trust, in turn, may lead the character to stop talking to the student.

Characters may also be configured to help the student. For example a character may be given the goal of developing trust with the student. It may deliberately behave in a fashion that elicits behavior from the player that increases that trust. For example, the character might greet the student so as to induce the student to greet the character in return.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently. In short, the scope of protection is limited solely by the claims that now follow. That scope is intended to be as broad as is reasonably consistent with the language that is used in the claims and to encompass all structural and functional equivalents.

For example, actions 104 that describe nonverbal movements may, like speech acts, be specified by a set of field values, which may similarly be entered through menu selections and/or the filling in of blanks. The fields may include items such as the name of the agent taking the action, the type of nonverbal action, and the name of the agent or agents to whom the nonverbal action may be addressed.

In lieu of or in addition to playing the role of one or more characters in a scene, a user may also be given the role of a director in a scene. In this embodiment, example, the user may be able to introduce an external event, such as an exploding bomb, restrict the way in which a character may act and/or alter one or more goals of a character.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

Nothing that has been stated or illustrated is intended to cause a dedication of any component, step, feature, object, benefit, advantage, or equivalent to the public, regardless of whether it is recited in the claims.

We claim:

1. An interactive story development system for developing an interactive story having a plurality of agents, comprising:
an action input system configured to receive actions that the agents should perform; and
a goal-fitting system configured to prioritize a plurality of goals for each agent based on the actions received by the action input system.

2. The interactive story development system of claim 1 wherein the actions include dialog and nonverbal movements that the agents should perform.

3. The interactive story development system of claim 1 wherein the input system is configured to receive actions in the form of menu selections.

4. The interactive story development system of claim 1 wherein the actions include speech acts, each of which contains the content of a speech communication.

5. The interactive story development system of claim 4 wherein the actions include a sequence of speech acts that collectively constitute at least part of a story.

6. The interactive story development system of claim 4 wherein the actions include alternate speech acts, each of which constitutes an alternate path in a story.

7. The interactive story development system of claim 4 wherein each speech act includes specification of a type of speech.

8. The interactive story development system of claim 4 wherein each speech act includes the name of the agent articulating the speech.

9. The interactive story development system of claim 4 wherein each speech act includes the name of the agent to whom the speech act is directed.

10. The interactive story development system of claim 4 wherein each speech act includes a proposition.

11. The interactive story development system of claim wherein 10 the action input system is configured to receive different types of propositions.

12. The interactive story development system of claim 10 wherein the speech acts and the propositions are received in the form of menu selections.

13. The interactive story development system of claim 1 further comprising an object attribute input system configured to receive identifications of objects that may be used in the story and attributes of each object.

14. The interactive story development system of claim 13 wherein the objects include agents and the attributes include attributes of the agents.

15. The interactive story development system of claim 13 wherein the object attribute input system is configured to receive information about relationships between the agents.

16. The interactive story development system of claim 14 wherein the goal-fitting system is configured to extract goals from attributes of agents.

17. The interactive story development system of claim 1 further comprising an action dynamics input system configured to receive action dynamics indicative of how actions of the agents affect attributes of the agents.

18. The interactive story development system of claim 17 wherein the goal-fitting system is configured to prioritize the plurality of goals also based on the action dynamics.

19. The interactive story development system of claim 18 wherein the goal-fitting system is configured to prioritize the goals for each agent based on whether the action dynamics indicates that the goals are furthered by the actions that the agent should perform as compared to actions that the agent should not perform.

20. The interactive story development system of claim 19 wherein the goal-fitting system is configured to increase the priority of a goal when action dynamics indicate that the goal is furthered by more by actions that the agent should perform than actions that the agent should not perform.

21. The interactive story development system of claim 19 wherein the goal-fitting system is configured to decrease the priority of a goal when action dynamics indicate that the goal is furthered more by actions that the agent should not perform than actions that the agent should perform.

22. The interactive story development system of claim 1 wherein the goals of an agent include maximizing or minimizing attributes of the agent.

23. The interactive story development system of claim 1 wherein the goals of an agent include changing a belief about the agent in the mind of another agent.

24. The interactive story development system of claim 1 wherein the goals of an agent include bringing about an action by the agent

25. The interactive story development system of claim 1 wherein the goals of an agent include bringing about an action by another agent.

26. The interactive story development system of claim 1 wherein the development system is configured to allow a user to control an agent during the interactive story after the goals of the other agents have been prioritized by the goal-fitting system and while the other agents act autonomously with those prioritized goals.

27. A method of developing an interactive story having a plurality of agents, comprising:
receiving actions that the agents should perform; and
prioritizing a plurality of goals for each agent based on the received actions.

28. The story developing method of claim 27 wherein the receiving actions includes receiving dialog and nonverbal movements that the agents should perform.

29. The story developing method of claim 27 wherein the receiving actions includes making menu selections.

30. The story developing method of claim 27 wherein the receiving actions includes receiving speech acts, each of which contains the content of a speech communication.

31. The story developing method of claim 30 wherein the receiving actions includes receiving a sequence of speech acts that collectively constitute at least part of a story.

32. The story developing method of claim 30 wherein the receiving actions includes receiving alternate speech acts, each of which constitutes an alternate path in a story.

33. The story developing method of claim 30 wherein each speech act includes specification of a type of speech.

34. The story developing method of claim 30 wherein each speech act includes the name of the agent articulating the speech.

35. The story developing method of claim 30 wherein each speech act includes the name of the agent to whom the speech act is directed.

36. The story developing method of claim 30 wherein each speech act includes a proposition.

37. The story developing method of claim 36 wherein the receiving the speech acts and the propositions include making menu selections.

38. The story developing method of claim 27 further comprising receiving identifications of objects that may be used in the story and attributes of each object.

39. The story developing method of claim 38 wherein the objects includes agents and the attributes include attributes of the agents.

40. The story developing method of claim 27 further comprising receiving information about relationships between the agents.

41. The story developing method of claim 39 further comprising extracting goals from attributes of agents.

42. The story developing method of claim 27 further comprising receiving action dynamics indicative of how actions of the agents affect attributes of the agents.

43. The story developing method of claim 42 wherein the prioritizing the plurality of goals is based also on the action dynamics.

44. The story developing method of claim 43 wherein the prioritizing the goals for each agent is based on whether the action dynamics indicate that the goals are furthered more by actions that the agent should perform than actions that the agent should not perform.

45. The story developing method of claim 44 wherein the prioritizing includes increasing the priority of a goal when action dynamics indicate that the goal is furthered more by actions that the agent should perform than by actions that the agent should not perform.

46. The story developing method of claim 44 wherein the prioritizing includes decreasing the priority of a goal when action dynamics indicate that the goal is furthered more by actions that the agent should not perform than by actions that the agent should perform.

47. The story developing method of claim 27 wherein the goals of an agent include maximizing or minimizing attributes of the agent.

48. The story developing method of claim 27 wherein the goals of an agent include changing a belief about the agent in the mind of another agent.

49. The story developing method of claim 27 wherein the goals of an agent include bringing about an action by the agent

50. The story developing method of claim 27 wherein the goals of an agent include bringing about an action by another agent.

51. The story developing method of claim 27 further comprising a user controlling one of the agents during the interactive story after the goals of the other agents have been prioritized and while the other agents act autonomously with those prioritized goals.

52. An interactive story development system for developing an interactive story having a plurality of agents, comprising:
means configured to receive actions that the agents should perform; and
means configured to prioritize a plurality of goals for each agent based on the actions received by the action input system.
